(19) United States
(12) Patent Application Publication
(10) Pub. No.: US 2026/0008612 A1
(43) Pub. Date: Jan. 8, 2026

(54) CONTAINER RECOVERY DEVICE AND OPERATION METHOD THEREOF

(71) Applicant: OYSTER ABLE CO., LTD., Seoul (KR)

(72) Inventors: Tae Goan BAE, Seoul (KR); Eric MICHEL GONZALEZ, Seoul (KR)

(21) Appl. No.: 18/992,555

(22) PCT Filed: Apr. 18, 2023
(86) PCT No.: PCT/KR2023/005193

§ 371 Date: Feb. 5, 2025

(30) Foreign Application Priority Data
Jul. 8, 2022 (KR) 10-2022-0084228

(51) Int. Cl. B65F 1/14

(52) U.S. Cl. CPC B65F 1/1463; B65F 2210/128; B65F 2210/165; B65F 2210/168

(57) ABSTRACT

A container recovery device and an operating method thereof are provided. The container recovery device according to the present invention comprises: an input part to which a container is input; a first motor for loading the container in a first space; a measurement part for measuring a container loading state of the first space; and a second motor which is configured to discharge the container loaded in the first space to a second space when the container loading state satisfies a predetermined criterion.

### TECHNICAL FIELD

The present invention relates to a container recovery device and an operation method thereof. More specifically, the present invention relates to a container recovery device for recovering reusable or disposable containers provided in food stores such by a beverage store or the like, and an operation method thereof.

### BACKGROUND ART

As social interest in the environment increases recently, various regulations for reducing use of disposable containers are proposed. In addition, people are gradually joining the social movement of refraining from using disposable containers in a way of using personal tumblers when visiting a coffee shop or the like.

However, most restaurants and coffee shops still use disposable containers when packaging food, and although the stores desire to use reusable or disposable containers, there is a problem in that the recovery rate of the reusable or disposable containers is low since a system for recovering the reusable or disposable containers is not established properly. In addition, when the reusable or disposable containers are not properly collected and thrown away, there is also a problem of generating environmental pollution.

Although there are events that provide a discount as a reward for using personal reusable or disposable containers such as tumblers or the like or provide reusable or disposable containers as a prize, use of the reusable or disposable containers has not been yet widespread for the various reasons as described above.

Particularly, from the perspective of business, it is difficult to invest manpower and cost in the collection process, defect detection process, and washing process provide and recover reusable or disposable containers, and from the perspective of general users, there is a problem in that users feel the process of recovering the reusable or disposable containers troublesome or there is no special motivation for collecting reusable or disposable containers.

### DISCLOSURE OF INVENTION

### Technical Problem

Therefore, the present invention has been made in view of the above problems, and it is an object of the present invention to provide a container recovery device and an operation method thereof, which can automatically recognize and recover reusable or disposable containers.

Another object of the present invention is to provide a container recovery device and an operation method thereof, which allow stores to conveniently provide reusable or disposable containers by recovering, loading, and sending reusable or disposable containers to be connected to a washing and recycling step.

Another object of the present invention is to provide a container recovery device and an operation method thereof, which can encourage consumers to return reusable or disposable containers more actively by providing a deposit or a reward to the consumers who return the reusable or disposable containers.

The technical problems of the present invention are not limited to the technical problems mentioned above, and unmentioned other technical problems will be clearly understood by those skilled in the art from the following descriptions.

### Technical Solution

To accomplish the above objects, according to an aspect of the present invention, there is provided a container recovery device comprising: an insertion unit in which a container is inserted; a first motor for loading the container in a first space; a measurement unit for measuring a container loading state of the first space; and a second motor for discharging the containers loaded in the first space to a second space when the container loading state satisfies a predetermined criterion.

As an embodiment, the measurement unit may include one or more sensors for sensing the number of containers loaded in the first space.

As an embodiment, the one or more sensors may include: a first sensor for sensing a container adjacent to a first side of the first space; and a second sensor for sensing a container adjacent to a second side of the first space, wherein the first side and the second side are sides facing each other.

As an embodiment, when the container loading state satisfies the predetermined criterion, the second motor may open a support located at the bottom of the first space, and discharge the containers loaded in the first space into the second space.

As an embodiment, the container recovery device may further comprise a recognition module for reading a recognition code of the container.

As an embodiment, the container recovery device may further comprise a posture adjustment module for adjusting a position or a posture of the container so that the recognition code of the container may be positioned within a recognition range of the recognition module.

As an embodiment, the container recovery device may further comprise: a hand detection unit for detecting whether a user's hand is in the insertion unit; and a third motor for moving a container displacement module to a front side of the container when the user's hand is not in the insertion unit.

As an embodiment, the container recovery device may further comprise an acceptability verification unit for determining whether the container inserted in the insertion unit is acceptable on the basis of the recognition code of the container, wherein the container may be returned to a user when the container is unacceptable as a result of the acceptability determination.

As an embodiment, the container recovery device may further comprise a payment processing unit for calculating a deposit or a reward corresponding to the container on the basis of the recognition code of the container.

As an embodiment, the deposit or reward may be calculated differently according to the number of times of recycling the container.

As an embodiment, the container recovery device may further comprise a display unit for displaying the deposit or reward calculated by the payment processing unit.

As an embodiment, the container recovery device may further comprise a communication unit for collecting container loading information of the second space and transmitting the container loading information to a remote management server.

As an embodiment, the remote management server may call a collection company that will collect the containers loaded in the container recovery device with reference to the container loading information of the second space, and the collection company may be determined on the basis of a priority calculated according to a distance between the container recovery device and the collection company and a service fee of the collection company.

As an embodiment, the priority may be determined on the basis of a calculation formula that calculates a weighted sum of the distance and the service fee, and a first weight applied to the distance or a second weight applied to the service fee may vary according to the container loading information of the second space.

According to another aspect of the present invention, there is provided an operation method of a container recovery device, the method performed by a computing device and comprising the steps of: recognizing a recognition code of a container inserted through an insertion unit; determining whether the container is acceptable on the basis of the recognition code; loading the container in a first space when the container is acceptable; measuring a container loading state of the first space; discharging the containers loaded in the first space to a second space when the container loading state satisfies a predetermined criterion; and collecting container loading information of the second space and transmitting the container loading information to a remote management server.

### Advantageous Effects

According to the embodiments of the present invention described above, the container recovery device may automatically recognize and recover acceptable reusable or disposable containers through a UID attached to the reusable or disposable containers.

In addition, as reusable or disposable containers are recovered, loaded, and sent through a container recovery device and automatically connected to a subsequent washing and recycling step, stores may conveniently provide reusable or disposable containers.

In addition, as a deposit or a reward is provided to a consumer who returns reusable or disposable containers, consumers may be encouraged to return reusable or disposable containers more actively.

### BRIEF DESCRIPTION OF THE DRAWINGS

FIG. 1 is a view schematically showing a reusable container recovery system according to an embodiment of the present invention.

FIG. 2 is a front view showing an exemplary configuration of a container recovery device according to an embodiment of the present invention.

FIG. 3 is an internal perspective view showing an exemplary configuration of a container recovery device according to an embodiment of the present invention.

FIG. 4 is an exemplary view showing a specific configuration of the loading unit shown in FIG. 3.

FIG. 5 is a view for further explaining a method of discharging a container loaded in a loading unit by driving the second motor of FIG. 4.

FIG. 6 is a view for explaining the internal structure of a container box.

FIG. 7 is a view for further explaining exemplary forms of UIDs imprinted on a container.

FIGS. 8 and 9 are views for further explaining a method of receiving container information from a container recovery device and performing history management and subsequent services by a control server at a remote site.

FIG. 10 is a flowchart illustrating an operation method of a container recovery device according to an embodiment of the present invention.

FIG. 11 is a block diagram showing an exemplary hardware configuration of a computing device in which various embodiments of the present invention are implemented.

FIG. 12 is a block diagram for further explaining main components of a container recovery device.

FIG. 13 is a view for further explaining additional configurations of a loading unit.

FIG. 14 is a view for further explaining a method of driving a rotation base module.

### BEST MODE FOR CARRYING OUT THE INVENTION

Hereinafter, embodiments of the present invention will be described in detail with reference to the accompanying drawings. The advantages and features of the present invention and a method for achieving them will become clear with reference to the embodiments described below in detail, together with the accompanying drawings. However, the technical spirit of the present invention is not limited to the embodiments described below, and may be implemented in various different forms, and the following embodiments are provided only to complete the technical spirit of the present invention and fully inform those skilled in the art of the scope of the present invention, and the technical spirit of the present invention is defined only by the scope of the claims.

When adding reference symbols to components in each drawing, it should be noted that like symbols are given to like components as much as possible although the components are shown in different drawings. In addition, when it is determined in describing the present invention that a specific description of a related known configuration or function may obscure the gist of the present invention, detailed description thereof will be omitted.

Unless defined otherwise, all terms (including technical and scientific terms) used in this specification may be used in a meaning that can be commonly understood by those skilled in the art. In addition, terms defined in commonly used dictionaries are not to be ideally or excessively interpreted unless explicitly and specifically defined. The terms used in this specification are for the purpose of describing the embodiments and are not intended to limit the present invention. In this specification, singular forms also include plural forms unless specifically stated in the phrase.

In addition, in describing the components of the present invention, terms such as first, second, A, B, (a), (b), and the like may be used. These terms are intended only to distinguish the components from other components, and the nature, order, sequence, or the like of the components are not limited by the terms. When it is described that a component is “connected,” “coupled,” or “combined” with another component, it should be understood that although the component may be directly connected or combined with another component, other components may also be “connected,” “coupled,” or “combined” between the components.

The reusable container referred to in this specification may be a reusable cup, but it is not limited thereto. For example, the reusable container may be a reusable plate or a reusable bowl.

Hereinafter, some embodiments of the present invention will be described in detail with reference to the accompanying drawings.

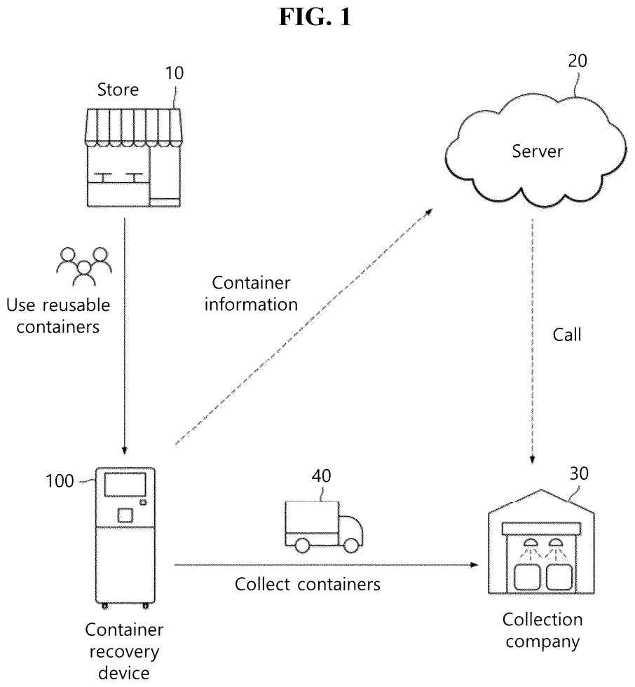

FIG. 1 is a view schematically showing a reusable container recovery system according to an embodiment of the present invention. Referring to FIG. 1, the reusable container recovery system may include a store 10, a container recovery device 100, a computing server 20, and/or a collection company 30.

The container recovery device 100 is a device that collects reusable containers provided by the store 10 after the containers are used. For example, when a user purchases food contained in a reusable container at the store 10, the reusable container is collected in a way of returning the used reusable container to the container recovery device 100 after the user eats all the food.

The container recovery device 100 according to an embodiment of the present invention may be connected to a cloud control server 20 at a remote site through a wired/wireless network to drive container recovery operation and transmit and receive container information, and perform communication with each other. The cloud control server 20 may also form a wired/wireless network with a terminal in the store 10 and a terminal of the collection company 30, in addition to the container recovery device 100, to perform communication with each other.

As an example, each of the networks may be implemented in any type of wired/wireless networks, such as a Local Area Network (LAN), a Wide Area Network (WAN), a Value-Added Network (VAN), a Personal Area Network (PAN), a mobile radiocommunication network, a satellite communication network, and the like.

As an embodiment, the container recovery device 100 may be a common device such as a kiosk or a stationary display device installed at a specific location. The container recovery device 100 may be an automated device that detects whether a reusable or disposable container is normally inserted when a user inserts a used reusable or disposable container into the container recovery device 100, and when the reusable or disposable container is normally inserted, it may sequentially load the reusable or disposable container in a predetermined loading space, and calculate and pay a deposit or a reward corresponding to the reusable or disposable container to the user.

As an embodiment, the container recovery device 100 may transmit loading information of the reusable or disposable containers collected by the container recovery device 100 to the cloud control server 20 as container information so that the cloud control server 20 may manage and monitor the recycling history of the reusable or disposable containers.

When the number of reusable or disposable containers loaded in the container recovery device 100 is larger than a predetermined number, the cloud control server 20 may call the collection company 30 to collect the reusable or disposable containers of the container recovery device 100 with reference to the container information transmitted by the container recovery device 100.

The collection company 30 may collect (40) the containers from the container recovery device 100 in response to the call from the cloud control server 20, and transmit information on the collected containers to the cloud control server 20. In addition, the collection company 30 may wash and supply the collected reusable or disposable containers to the store 10.

According to the reusable container recovery system of FIG. 1 as described above, recovery and recycling of reusable or disposable containers may be easily accomplished by automatically collecting, loading, and sending used reusable or disposable containers through the container recovery device 100, and connecting to a washing and recycling step.

Hereinafter, the specific configuration and function of the container recovery device 100 will be described in more detail.

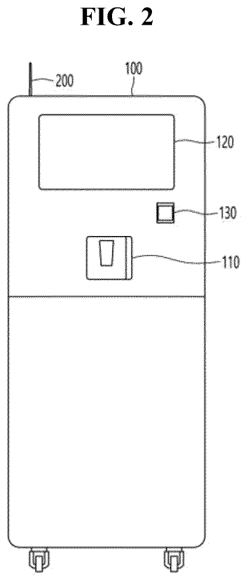

FIG. 2 is a front view showing an exemplary configuration of a container recovery device according to an embodiment of the present invention. Referring to FIG. 2, an insertion unit 110, a display 120, a user recognition unit 130, and a communication unit 200 may be provided on the front side of the container recovery device 100.

The insertion unit 110 is a unit in which a reusable or disposable container is inserted. A door that can be opened and closed may be attached to the insertion unit 110.

The display 120 is a configuration that displays information and a User Interface (UI) related to the operation of the container recovery device 100 to the user. The display 120 may be configured as a Liquid Crystal Display (LCD), Organic Light Emitting Diodes (OLED), or other display device.

The user recognition unit 130 is a configuration that recognizes various information related to the user. The user recognition unit 130 may include a sensor that may detect approach of an object or recognize a barcode, a QR code, or the like.

For example, when the user recognition unit 130 recognizes that a user is approaching through a sensor, the door of the insertion unit 110 may be opened so that a reusable or disposable container may be inserted into the insertion unit 110. At this point, the display 120 may display to the user that currently a reusable or disposable container may be inserted to encourage the user to insert a reusable or disposable container into the insertion unit 110.

The communication unit 200 is a module for communicating with an external device such as the computing server 20.

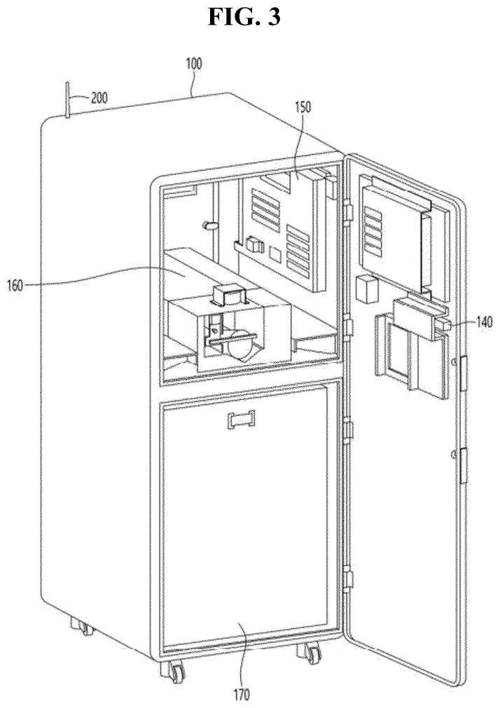

FIG. 3 is an internal perspective view showing an exemplary configuration of a container recovery device according to an embodiment of the present invention. Referring to FIG. 3, a hand detection unit 140, a control unit 150, a loading unit 160, and/or a container box 170 may be provided inside the container recovery device 100.

The hand detection unit 140 detects whether a user's hand is in the insertion unit. When the container recovery device 100 operates while a user's hand is in the insertion unit, it may injure the user. To prevent the accident, the hand detection unit 140 detects whether a user's hand is in the insertion unit, and the container recovery device 100 may operate only when a user's hand is not in the insertion unit.

The control unit 150 controls the operation of each component of the container recovery device 100. For example, the control unit 150 may control the operation of the insertion unit 110, the display 120, the user recognition unit 130, the hand detection unit 140, and/or the loading unit 160 shown in FIGS. 2 and 3. The control unit 150 is a computing device and may include at least one processor, a bus, a communication interface, a memory, and/or a storage.

The control unit 150 is an embedded system and may include at least one power module, a programmable device (e.g., a microprocessor), a bus module, a communication interface (e.g., Bluetooth, Wi-Fi, etc.), a memory, and/or a storage.

The control unit 150 may execute a firmware program to process and control all hardware components of the container recovery device 100.

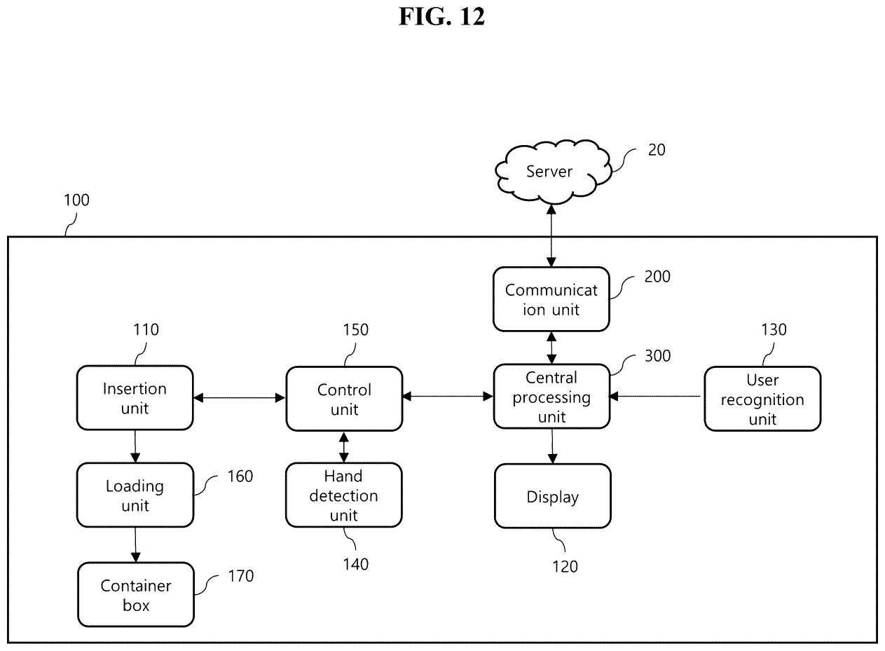

The control unit 150 may be designed to be compatible with any general-purpose computing device, such as a central processing unit (300 of FIG. 12), for the purpose of hardware control communication, data sharing, and instruction commanding.

The loading unit 160 receives a reusable or disposable container inserted by a user, recognizes the reusable or disposable container, and confirms whether the container is an acceptable container. When the inserted reusable or disposable container is an unacceptable container, the loading unit 160 transmits a signal indicating that it is an unacceptable container to the control unit 150, and the control unit 150 may display a message, through the display 120, informing the user to take back the inserted container. Meanwhile, when the inserted reusable or disposable container is an acceptable container, the loading unit 160 sequentially loads the container inserted into a first space inside the loading unit 160. In addition, when the number of containers loaded in the first space exceeds a predetermined number, the loading unit 160 discharges the loaded containers into the inner space of the container box 170.

The container box 170 loads and stores reusable or disposable containers discharged from the loading unit 160. The reusable or disposable containers stored in the container box 170 may be collected later by a collection company.

As an embodiment, the container recovery device 100 may further include a payment processing unit (not shown) for calculating a deposit or a reward corresponding to the returned reusable or disposable container when the user returns the reusable or disposable container. The payment processing unit may be a module integrated with the control unit 150 or may be a separate module distinguished from the control unit 150.

At this point, the deposit or reward calculated by the payment processing unit may be calculated on the basis of a recognition code imprinted on the returned reusable or disposable container. For example, when the recognition code of the reusable or disposable container is recognized through a recognition module provided in the loading unit 160, the payment processing unit may calculate a predetermined amount corresponding to the recognized code as a deposit or a reward. For example, when the recognition code of the reusable or disposable container is SSS101, 100 Korean Won (KRW) may be calculated, and when it is SSS102, 150 KRW may be calculated as a deposit or a reward for returning the reusable or disposable container.

As an embodiment, the payment processing unit may calculate the deposit or reward to be different according to the number of times of recycling the returned reusable or disposable container. Since durability of the reusable or disposable container decreases as recycling of the reusable or disposable container is repeated, the residual value of the reusable or disposable container may decrease as the number of times of recycling the reusable or disposable container increases. Accordingly, the payment processing unit may calculate a smaller amount as the deposit or reward as the number of times of recycling the reusable or disposable container increases, such as calculating 150 KRW as the deposit or reward when the reusable or disposable container has been recycled 5 times and 100 KRW when the reusable or disposable container has been recycled 10 times.

As an embodiment, the deposit or reward calculated by the payment processing unit may be displayed to the user.

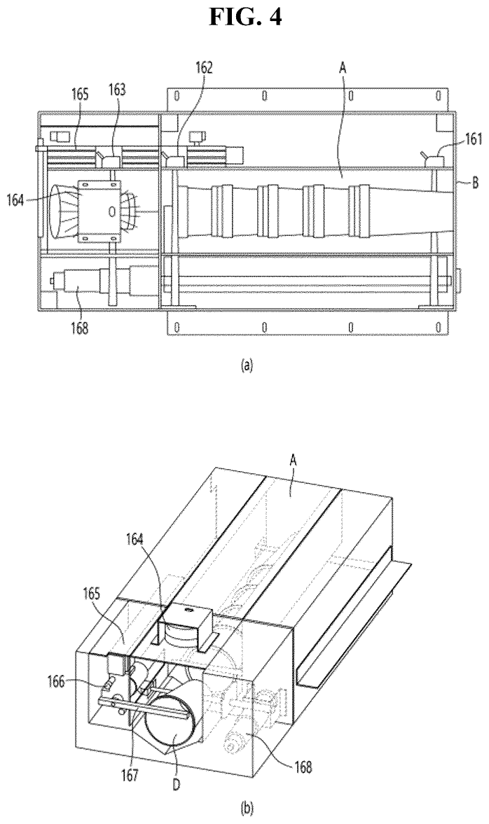

FIG. 4 is an exemplary view showing a specific configuration of the loading unit shown in FIG. 3. FIG. 4(a) is a plan perspective view of the loading unit 160, and FIG. 4(b) is a perspective view of the loading unit 160.

Referring to FIGS. 4(a) and (b), the loading unit 160 may include a first space A in which reusable or disposable containers inserted through the insertion unit are sequentially loaded, measurement units 161, 162, 163 for measuring the container loading state of the first space A, a recognition module 164 for reading the recognition code of a reusable or disposable container D, a first motor 165 for loading the reusable or disposable container D in the first space A, an actuator 166, a third motor for moving a container displacement module 167 to the front side of the reusable or disposable container D, and a second motor 168 for discharging the containers loaded in the first space A to a second space (e.g., the inner space of the container box).

The specific operation method of the loading unit 160 is as described below.

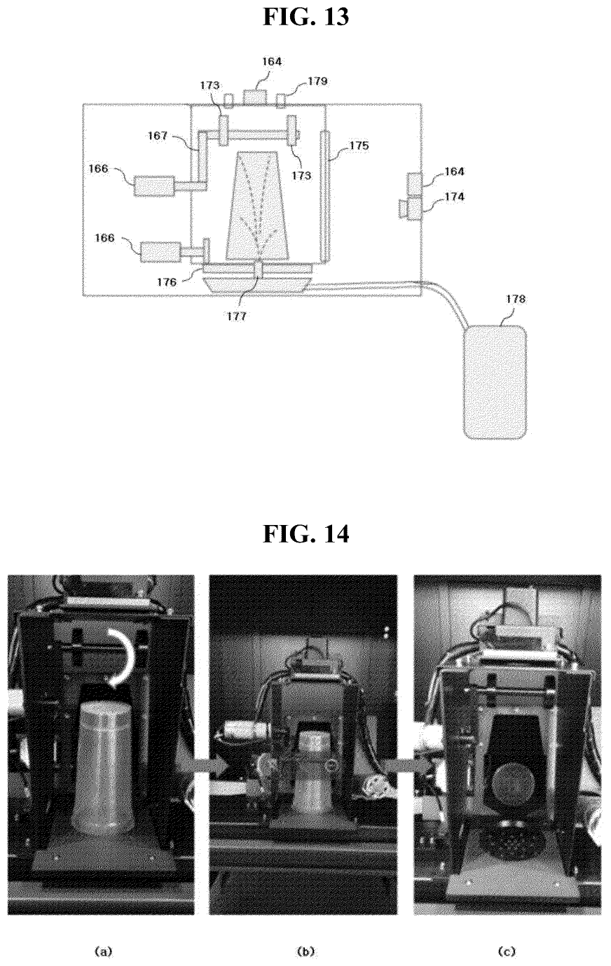

When a reusable or disposable container D is inserted through the insertion unit, whether a user's hand is in the insertion unit is detected. When a user's hand is not detected in the insertion unit, the third motor is driven, and the container displacement module 167 is moved to the front side of the reusable or disposable container D. The container displacement module 167 is a configuration that supports the front side of the reusable or disposable container D when the first motor 165 loads the reusable or disposable container D in the first space A so that the reusable or disposable container D may be drawn to the first space A according to the movement of the first motor 165. The actuator 166 may be, for example, a DC motor or a step motor. At least one actuator 166 controls the container displacement module 167 and the rotation base module (176 of FIG. 13).

In addition, the recognition code imprinted on the reusable or disposable container D is recognized through the recognition module 164. The recognition code may be a symbol, a figure, or a letter representing the Unique Identifier (UID) of the reusable or disposable container D, and may be imprinted on any one side of the reusable or disposable container D. In this embodiment, it is assumed that the recognition code is imprinted on the side surface of the reusable or disposable container D.

As an embodiment, the loading unit 160 may further include a posture adjustment module (not shown) for adjusting the position or posture of the reusable or disposable container D. For example, when the recognition code is imprinted on one side surface of the reusable or disposable container D, and the reusable or disposable container D is inserted while the recognition code faces downward, it may be difficult to recognize the recognition code as the recognition code is not positioned within a range that can be recognized by the recognition module 164. In this case, the posture adjustment module may adjust the position or posture of the reusable or disposable container D so that the recognition code of the reusable or disposable container D is positioned in front of the recognition module 164.

When the recognition code of the reusable or disposable container D is recognized through the recognition module 164, it is determined whether the reusable or disposable container D is an acceptable container on the basis of the recognition code. For example, due to the issues such as the dimension or the like of the reusable or disposable container, it may be set only specific reusable or disposable containers are allowed to be returned to the container recovery device.

At this point, when the type of the reusable or disposable container D determined by analyzing the recognition code is a type that is not allowed to return, the reusable or disposable container D is determined as an unacceptable container. In this case, the container recovery device may display a message indicating that the inserted reusable or disposable container is not a container that can be returned, and return the reusable or disposable container to the user.

On the other hand, when the type of the reusable or disposable container D is a type that is allowed to return, the reusable or disposable container D is determined as an acceptable container. In this case, as the first motor 165 is driven to move the reusable or disposable container D toward the first space A, the reusable or disposable container D is loaded in the first space A. As an embodiment, the first motor 165 may be a step motor that may control the movement in steps.

The measurement units 161, 162, 163 include one or more sensors. The measurement units 161, 162, 163 may include a first sensor 161 and a second sensor 162 for sensing the number of reusable or disposable containers loaded in the first space A, and/or a third sensor 163 for detecting whether a reusable or disposable container D is inserted.

As an embodiment, the first sensor 161, the second sensor 162, and/or the third sensor 163 may be photosensors that emit laser beams. At this point, a reflector is provided on the opposite side of each of the sensors 161, 162, 163, and when the laser beam emitted from each of the sensors 161, 162, 163 is reflected and returned from the reflector, it is recognized that there is no object at the location, and when the laser beam emitted from each of the sensors 161, 162, 163 is not returned, it is recognized that there is an object at the location.

The method of sensing the number of reusable or disposable containers loaded in the first space A using the first sensor 161 and the second sensor 162 is as described below.

The first sensor 161 senses a container adjacent to a first side B of the first space A. When a reusable or disposable container is loaded, it is loaded from the first side B, and therefore, when a reusable or disposable container is not detected by the first sensor 161, the number of reusable or disposable containers loaded in the first space A will be 0. On the contrary, when a reusable or disposable container is detected by the first sensor 161, at least one reusable or disposable container is loaded in the first space A.

The second sensor 162 senses a container adjacent to a second side C of the first space A. At this point, the second side C is a side opposite to the first side B, and it may be regarded that the maximum loading capacity of the first space A is defined by the second side C. Accordingly, when a reusable or disposable container is detected by the second sensor 162, this may mean that the first space A is loaded with reusable or disposable containers up to the maximum loading capacity. On the contrary, when a reusable or disposable container is not detected by the second sensor 162, this may mean that the first space A still has a room for additionally loading reusable or disposable containers.

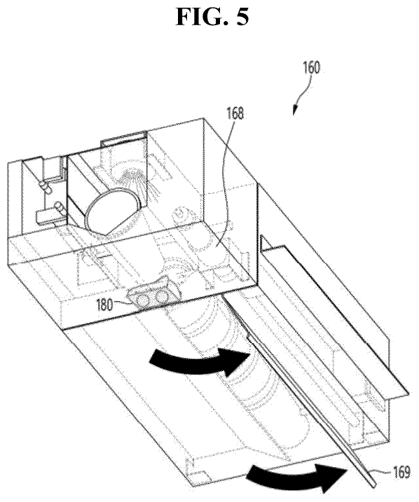

When the container loading state of the first space A measured through the measurement units 161, 162, 163 satisfies a predetermined criterion, for example, a reusable or disposable container is detected by both the first sensor 161 and the second sensor 162, the second motor 168 is driven, and the reusable or disposable containers loaded in the first space A are discharged to the second space. For further explanation, refer to FIG. 5.

FIG. 5 is a view for further explaining a method of discharging a container loaded in a loading unit by driving the second motor of FIG. 4.

As described above, when the container loading state of the first space A satisfies a predetermined criterion, the second motor 168 is driven to open a support 169 located at the bottom of the first space. As the second space is located under the support 169, when the support 169 rotates 90 degrees ed, the reusable or disposable containers in the first space are discharged to the second space by gravity.

A container box load detection module 180 is provided at the bottom of the loading unit 160. The container box load detection module 180 may include, for example, an ultrasonic sensor, an IR sensor, or a distance sensor, and acquires information on the remaining space of the container box 170 in real time. The acquired real-time information may be used to increase accuracy of calculation of the mathematical formula described in FIG. 8.

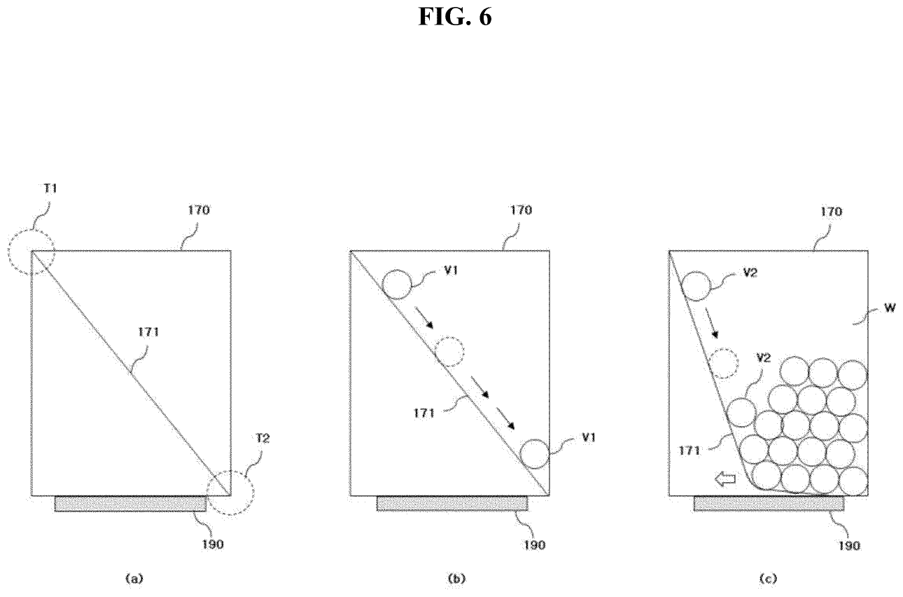

According to the configuration of the loading unit 160 described in FIGS. 5 and 6, a series of operations, such as reading a recognition code of a reusable or disposable container inserted by a user, verifying whether the reusable or disposable container is acceptable, sequentially loading the reusable or disposable container in the first space inside the loading unit 160 when the container is an acceptable container, opening the support at the bottom of the first space when the number of containers loaded in the first space exceeds a predetermined criterion, and discharging the loaded reusable or disposable containers, may be performed automatically. Through the operations, reusable or disposable containers may be automatically recognized and recovered without direct intervention of a person in the process of recovering reusable or disposable containers.

FIG. 6 is a view for explaining the internal structure of a container box. In FIG. 6, a configuration for buffering the impact of dropping the reusable or disposable containers in the loading unit when the reusable or disposable containers are discharged to the container box is described.

Referring to FIG. 6(a), an embodiment of providing a buffer plate 171 inside the container box 170 is shown. Although the buffer plate 171 may be made of an elastic plastic material, the material of the buffer plate 171 is not limited thereto.

The upper end T1 of the buffer plate 171 is fixed to the top portion of the container box 170 and does not move. On the other hand, as the lower end T2 of the buffer plate 171 is not fixed to the container box 170, the end may move as reusable or disposable containers are loaded in the container box 170. A detailed description thereof will be continued with reference to FIGS. 6(b) and (c).

FIG. 6(b) shows a method of loading when there is no reusable or disposable container loaded in the container box 170. The buffer plate 171 forms an inclined surface from a corner of the container box 170 to an opposite corner. When a reusable or disposable container V1 is discharged from the loading unit, the reusable or disposable container V1 is placed on the upper portion of the buffer plate 171, rolls down along the inclined surface of the buffer plate 171, and reaches the lower portion of the container box 170. Accordingly, the reusable or disposable container V1 does not directly fall to the lower portion of the container box 170, but rolls down along the buffer plate 171, so that the impact at the time of discharging the reusable or disposable container V1 is alleviated.

Meanwhile, when the buffer plate 171 is made of an elastic material, the lower end of the buffer plate 171 moves as reusable or disposable containers are loaded, and the loading space of the container box 170 may be utilized more efficiently.

Referring to FIG. 6(c), an example in which a predetermined number of reusable or disposable containers are loaded in the container box 170 is shown. In this case, since the lower end of the buffer plate 171 is not fixed, the lower end of the buffer plate 171 moves toward the left due to the weight of previously loaded reusable or disposable containers, and accordingly, the loading space W in the container box 170 is also expanded.

Meanwhile, even in the case of FIG. 6(c), when a reusable or disposable container V2 is discharged from the loading unit, the reusable or disposable container V2 is placed on the upper portion of the buffer plate 171, rolls down along the inclined surface of the buffer plate 171, and reaches the lower portion of the container box 170. At this point, although the inclination angle of the inclined surface is steeper than that shown in FIG. 6(b) according to the movement of the buffer plate 171, the falling distance is shorter, so that the overall impact applied to the reusable or disposable container V2 does not differ greatly between (b) and (c) of FIG. 6.

A container box weight measurement module 190 may include, for example, a load cell or a digital scale, and measures the weight of the container box 170 in real time. The measured real-time weight may be used to increase accuracy of calculation of the mathematical formula described in FIG. 8.

Meanwhile, as an embodiment, the container box 170 may further include a reflector (not shown), a cup detection sensor (not shown), and a guide rail (not shown).

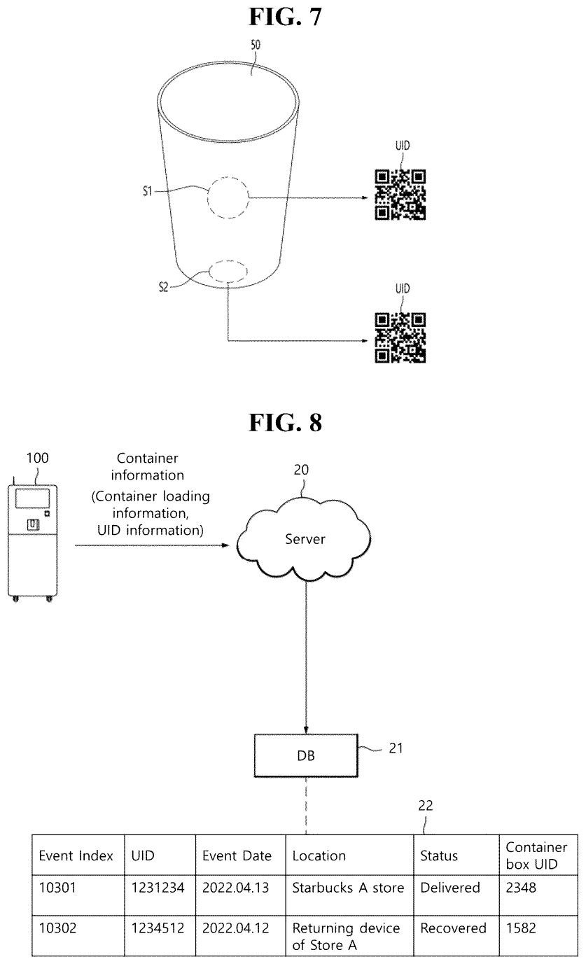

FIG. 7 is a view for further explaining exemplary forms of UIDs imprinted on a container.

A UID is a unique identifier assigned to a reusable or disposable container 50, and may be in the form of a QR code as shown in FIG. 7, but it is not limited thereto. For example, the UID may be in the form of a barcode, a figure, a picture, a symbol, or a combination thereof.

The UID may be imprinted on one side of the reusable or disposable container 50. For example, the UID may be imprinted on the side surface S1 of the reusable or disposable container, on the bottom S2 of the reusable or disposable container, or on both the side surface S1 and the bottom S2 of the reusable or disposable container.

Meanwhile, although an expression that the UID is imprinted is used herein, this does not necessarily mean that it is imprinted on the surface of the reusable or disposable container 50 in an embossed or engraved form. The meaning of imprinting herein may include printing the UID on the surface of the reusable or disposable container 50 or embedding the UID inside the reusable or disposable container 50.

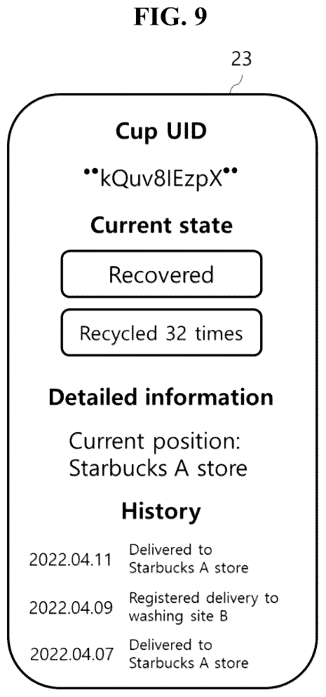

FIGS. 8 and 9 are views for further explaining a method of receiving container information from a container recovery device and performing history management and subsequent services by a control server at a remote site.

In the embodiment of FIG. 8, the container recovery device 100 includes a communication unit (not shown) capable of communicating with a remote management server, i.e., a cloud control server 20.

The container recovery device 100 transmits container information of a reusable or disposable container recovered by itself to the cloud control server 20 through the communication unit. The container information may include container loading information indicating the container loading state of the second space (e.g., a container box) inside the container recovery device 100, and/or UID information of the reusable or disposable container recovered by the container recovery device 100.

As an embodiment, the cloud control server 20 updates recycling history 22 of the reusable or disposable container recorded in the database 21 on the basis of the UID information of the container information. For example, when the cloud control server 20 receives UID information of a reusable or disposable container having a UID of ‘1234512’ from the container recovery device 100, it searches for a related item in the database 21 on the basis of the UID and updates information such as the event occurrence date (Event Date), the event occurrence location (Location), the current status (Status) of the reusable or disposable container, or the UID of the container box (Box UID) in which the reusable or disposable container is loaded. The updated recycling history 22 of the reusable or disposable container may be provided through a mobile application or a screen 23 of a user terminal as shown in FIG. 8.

As an embodiment, the cloud control server 20 may call a collection company that will collect the containers loaded in the container recovery device 100 on the basis of the container loading information of the container information. For example, when the container loading information that the cloud control server 20 has received is ‘full’, the cloud control server 20 may call a collection company near the container recovery device 100 and request collection of the containers.

At this point, the collection company may be determined on the basis of a priority calculated according to the distance between the container recovery device 100 and the collection company and the service fee of the collection company. For example, the shorter the distance to the container recovery device 100, the faster the containers may be collected, so that the shorter the distance, the higher the priority, and the lower the service fee of the collection company, the higher the priority.

As an embodiment, the priority may be determined on the basis of a calculation formula that calculates a weighted sum of the distance between the container recovery device 100 and the collection company and the service fee of the collection company. At this point, the calculation formula is the mathematical formula shown below, and when a calling score is determined by the calculation formula, the priority may be determined in a method of assigning a rank in order of higher calling scores.

$$Calling score = 1 / [ ( k 1 * P ) + ( k 2 * Q ) ] \qquad Mathematical formula$$

Here, k1 is a predetermined first weight, k2 is a predetermined second weight, P is the distance between the container recovery device and the collection company, and Q is the service fee of the collection company.

According to the mathematical formula, the longer the distance between the container recovery device and the collection company, and the higher the service fee of the collection company, the lower the calling score will be calculated, and accordingly, a lower priority will be assigned.

As an embodiment, the first weight or the second weight may vary according to the container loading information of the container recovery device 100. First, it is assumed that the container recovery device 100 transmits two or more pieces of container loading information according to the container loading state of the second space. For example, it is assumed that the container recovery device 100 transmits container loading information ‘FULL’ when the reusable or disposable containers are loaded 80% or more of the second space, and transmits container loading information ‘URGENT’ when the reusable or disposable containers are loaded 95% or more of the second space.

In this case, when ‘FULL’ is received as the container loading information, the cloud control server 20 determines that it is not a very urgent situation although collection of the containers is needed, and may determine the calling score using normal values as the first and second weights (for example, k1=k2=1).

On the other hand, when ‘URGENT’ is received as the container loading information, the cloud control server 20 determines that collection of the containers is very urgent, and may determine the calling score by increasing the first weight, which is the weight for the distance, from the normal value and decreasing the second weight, which is the weight for the service fee, from the normal value (for example, k1=2, k2=0.5).

According to the embodiment, in a situation where the container loading information is ‘URGENT’, as a collection company in a shorter distance is called first although the service fee is somewhat higher, the containers loaded in the container recovery device 100 may be collected more quickly.

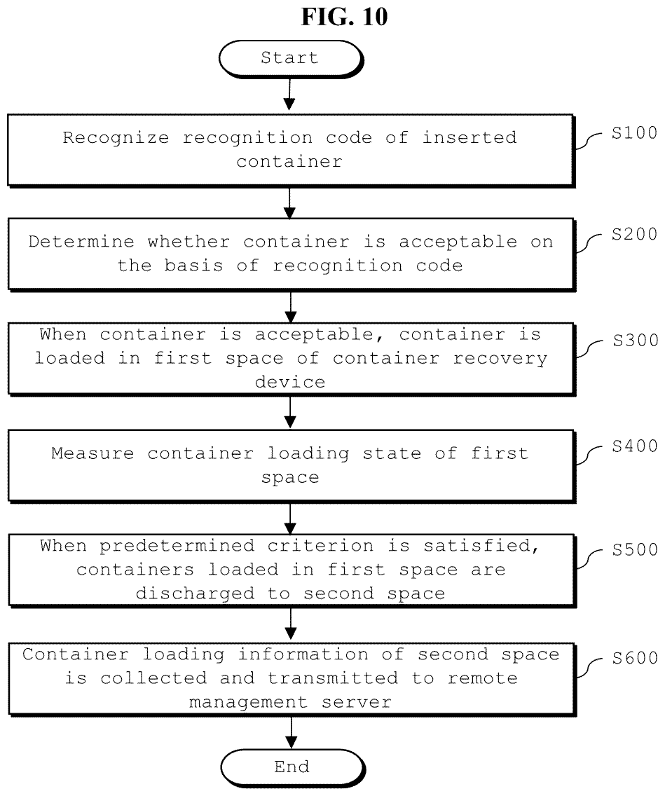

FIG. 10 is a flowchart illustrating an operation method of a container recovery device according to an embodiment of the present invention. The operation method of the container recovery device shown in FIG. 10 is performed by the container recovery device 100 shown in FIG. 1. Therefore, when a subject performing the operations is omitted in the following steps, it is assumed that the performing subject is the container recovery device 100.

At step S100, when a user inserts a reusable or disposable container through the insertion unit of the container recovery device, the recognition code of the inserted reusable or disposable container is recognized through the recognition module.

At step S200, whether the reusable or disposable container is acceptable is determined on the basis of the recognition code.

When the inserted reusable or disposable container is an unacceptable container, a message indicating that the container is unacceptable is displayed to the user, and the inserted container is returned to the user, and then the present embodiment is terminated. On the other hand, when the inserted reusable or disposable container is an acceptable container, the present embodiment proceeds to step S300.

At step S300, since the reusable or disposable container is acceptable, the reusable or disposable container is loaded in the first space inside the loading unit of the container recovery device.

At step S400, the container loading state of the first space is measured. The container loading state may be measured in a method of detecting the presence of a reusable or disposable container adjacent to the first side of the first space and the presence of a reusable or disposable container adjacent to the second side opposite to the first side.

At step S500, when the result of measuring the container loading state satisfies a predetermined criterion, the reusable or disposable containers loaded in the first space are discharged to the second space.

As an embodiment, the predetermined criterion may be detection of both a reusable or disposable container adjacent to the first side and a reusable or disposable container adjacent to the second side.

The second space may be the inner space of the container box located under the loading unit.

At step S600, container loading information of the second space is collected and transmitted to a remote management server. For example, when the reusable or disposable containers are loaded 80% or more of the second space, container loading information ‘FULL’ may be transmitted to the remote management server, and when the reusable or disposable containers are loaded 95% or more of the second space, container loading information ‘URGENT’ may be transmitted to the remote management server.

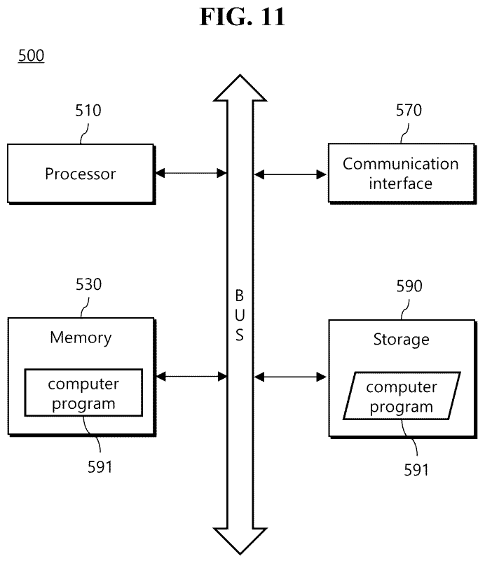

Hereinafter, an exemplary computing device 500 in which the methods described in various embodiments of the present invention are implemented will be described with reference to FIG. 11. For example, the computing device 500 of FIG. 11 may be the container recovery device 100 shown in FIG. 1 or the control unit 150 shown in FIG. 3.

FIG. 11 is an exemplary hardware configuration diagram showing the computing device 500.

As shown in FIG. 11, the computing device 500 may include one or more processors 510, a bus 550, a communication interface 570, a memory 530 for loading a computer program 591 executed by the processor 510, and a storage 590 for storing the computer program 591. However, only the components related to the embodiment of the present invention are shown in FIG. 11. Therefore, those skilled in the art may know that other general components may be included, in addition to the components shown in FIG. 11.

The processor 510 controls the overall operation of each component of the computing device 500. The processor 510 may be configured to include at least one among a Central Processing Unit (CPU), a Micro Processor Unit (MPU), a Micro Controller Unit (MCU), a Graphics Processing Unit (GPU), and any other types of processors well known in the technical field of the present invention. In addition, the processor 510 may perform operation of at least one application or program for executing a method/operation according to various embodiments of the present invention. The computing device 500 may include one or more processors.

The memory 530 stores various data, commands, and/or information. The memory 530 may load one or more programs 591 from the storage 590 to execute the methods/operations according to various embodiments of the present invention. An example of the memory 530 may be RAM, but it is not limited thereto.

The bus 550 provides communication functions between the components of the computing device 500. The bus 550 may be implemented as various types of buses such as an address bus, a data bus, a control bus, and the like.

The communication interface 570 supports wired and wireless Internet communications of the computing device 500. The communication interface 570 may also support various communication methods in addition to Internet communications. To this end, the communication interface 570 may be configured to include a communication module well known in the technical field of the present invention.

The storage 590 may non-temporarily store one or more computer programs 591. The storage 590 may be configured to include volatile memory such as Read Only Memory (ROM), Erasable Programmable ROM (EPROM), Electrically Erasable Programmable ROM (EEPROM), flash memory, a hard disk, a removable disk, or any form of computer-readable recording medium well known in the technical field of the present invention.

The computer program 591 may include one or more instructions implementing the methods/operations according to various embodiments of the present invention. When the computer program 591 is loaded on the memory 530, the processor 510 may perform the methods/operations according to various embodiments of the present invention by executing the one or more instructions.

FIG. 12 is a block diagram for further explaining main components of a container recovery device. Referring to FIG. 12, the container recovery device 100 may include an insertion unit 110, a display 120, a user recognition unit 130, a hand detection unit 140, a control unit 150, a loading unit 160, a container box 170, a communication unit 200, and/or a central processing unit 300.

Since the insertion unit 110, the display 120, the user recognition unit 130, the hand detection unit 140, the control unit 150, the loading unit 160, and the container box 170 shown in FIG. 12 have been described above, additional descriptions are omitted herein to avoid duplication of explanation.

The communication unit 200 is a transmission/reception module for communication between the container recovery device 100 and the remote computing server 20. The communication unit 200 may perform a function of transmitting data generated by the container recovery device 100 through a network, such as Ethernet or Wi-Fi, and searching for information and commands from the remote computing server 20.

The central processing unit 300 is a dedicated computer that performs all processes related to the container recovery device 100. The central processing unit 300 is a computing device and may include at least one power module, a processor, a bus port, a communication interface, a memory, and/or a storage device.

The central processing unit 300 executes software source codes to process and control commercial peripherals, such as QR scanners, web cameras, LED monitors, and other devices, and executes user interfaces. The central processing unit 300 may directly communicate with the control unit 150, the user recognition unit 130, the display 120, and the communication unit 200.

FIG. 13 is a view for further explaining additional configurations of a loading unit.

Referring to FIG. 13, in addition to the components 164, 166, 167 as described above, the loading unit may further include a container holder 173, a visual inspection module 174, a transparent protection wall 175, a rotation base module 176, a rinsing module 177, a drain module 178, and/or an entrance hole lighting module 179.

The container holder 173 supports containers against the flow of water during the rinsing and container displacement operations.

The visual inspection module 174 is configured of a digital camera, for example, a Deep 3D camera, an IR camera, a web camera, or a combination thereof, and includes a machine learning function for performing image processing and artificial intelligence computing processes to verify the quality of recovered containers. At this point, the process that verifies the quality of recovered containers may include object detection and object inspection to confirm the physical condition of the containers (for example, dust, abnormality, failure, etc.).

The transparent protection wall 175 provides a transparent protection wall for preventing the inspection by the visual inspection module 174 from being damaged or contaminated by liquids and other residues. The transparent protection wall 175 may include, for example, acrylic, glass, or the like.

The rotation base module 176 is an alternative to an electronic valve and may perform a function of manually activating the rinsing module 177 and rotating the container so that the visual inspection module 174 may see the container from the entire viewpoint (360 degrees).

The rinsing module 177 may be manually operated by a user or may be automatically operated on the basis of an inspection result of the visual inspection module 174. The rinsing module 177 may include at least one electronic valve for activating or deactivating flow of water from a water source.

The drain module 178 collects liquid or solid residue from the rinsing module 177 and the inserted containers. The drain module 178 may include at least one among a tray, a pipe, and a tank for storing the residues.

The entrance hole lighting module 179 is a configuration for improving visibility of the containers and assisting the operation and process of the recognition module 164 and the visual inspection module 174. The entrance hole lighting module 179 may include, for example, light-emitting diodes.

FIG. 14 is a view for further explaining a method of driving a rotation base module. Hereinafter, it will be described with reference to the drawing.

First, as shown in FIG. 14(a), after a container is placed on the rotation base module, a link bar rotates.

Next, as shown in FIG. 14(b), the link bar rotates and pulls the container into the loading unit, and the container falls down freely and is loaded.

Finally, as shown in FIG. 14(c), after loading of the container is completed, it returns to the initial state to load a next container.

The technical spirit of the present invention described so far may be implemented as a computer-readable code on a computer-readable medium. The computer-readable recording medium may be, for example, a removable recording medium (CD, DVD, Blu-ray disc, USB storage device, removable hard disk) or a fixed recording medium (ROM, RAM, computer-attached hard disk). The computer program recorded on the computer-readable recording medium may be transmitted to another computing device through a network such as the Internet or the like to be installed in another computing device, and therefore, may be used in another computing device.

Although the embodiments of the present invention have been described with reference to the accompanying drawings, those skilled in the art will understand that the present invention may be implemented in other specific forms without changing the technical spirit or essential features thereof. Therefore, it should be understood that the embodiments described above are exemplary and not restrictive in all respects. The protection scope of the present invention should be interpreted by the following claims, and all technical spirits within the equivalent scope should be interpreted as being included in the scope of the technical spirit defined by the present invention.

1. A container recovery device comprising:
an insertion unit in which a container is inserted;
a first motor for loading the container in a first space;
a measurement unit for measuring a container loading state of the first space; and
a second motor for discharging the containers loaded in the first space to a second space when the container loading state satisfies a predetermined criterion.

2. The device according to claim 1, wherein the measurement unit includes one or more sensors for sensing the number of containers loaded in the first space.

3. The device according to claim 2, wherein the one or more sensors include:
a first sensor for sensing a container adjacent to a first side of the first space; and
a second sensor for sensing a container adjacent to a second side of the first space, wherein
the first side and the second side are sides facing each other.

4. The device according to claim 1, wherein when the container loading state satisfies the predetermined criterion, the second motor opens a support located at the bottom of the first space, and discharges the containers loaded in the first space into the second space.

5. The device according to claim 1, further comprising a recognition module for reading a recognition code of the container.

6. The device according to claim 5, further comprising a posture adjustment module for adjusting a position or a posture of the container so that the recognition code of the container is positioned within a recognition range of the recognition module.

7. The device according to claim 1, further comprising:
a hand detection unit for detecting whether a user's hand is in the insertion unit; and
a third motor for moving a container displacement module to a front side of the container when the user's hand is not in the insertion unit.

8. The device according to claim 1, further comprising an acceptability verification unit for determining whether the container inserted in the insertion unit is acceptable on the basis of the recognition code of the container, wherein the container is returned to a user when the container is unacceptable as a result of the acceptability determination.

9. The device according to claim 1, further comprising a payment processing unit for calculating a deposit or a reward corresponding to the container on the basis of the recognition code of the container.

10. The device according to claim 9, wherein the deposit or reward is calculated differently according to the number of times of recycling the container.

11. The device according to claim 9, further comprising a display unit for displaying the deposit or reward calculated by the payment processing unit.

12. The device according to claim 1, further comprising a communication unit for collecting container loading information of the second space and transmitting the container loading information to a remote management server.

13. The device according to claim 12, wherein the remote management server calls a collection company that will collect the containers loaded in the container recovery device with reference to the container loading information of the second space, and the collection company is determined on the basis of a priority calculated according to a distance between the container recovery device and the collection company and a service fee of the collection company.

14. The device according to claim 13, wherein the priority is determined on the basis of a calculation formula that calculates a weighted sum of the distance and the service fee, and a first weight applied to the distance or a second weight applied to the service fee vary according to the container loading information of the second space.

15. An operation method of a container recovery device, the method performed by a computing device and comprising the steps of:
recognizing a recognition code of a container inserted through an insertion unit;
determining whether the container is acceptable on the basis of the recognition code;
loading the container in a first space when the container is acceptable;
measuring a container loading state of the first space;
discharging the containers loaded in the first space to a second space when the container loading state satisfies a predetermined criterion; and
collecting container loading information of the second space and transmitting the container loading information to a remote management server.
